(19) United States
(12) Patent Application Publication
(10) Pub. No.: US 2009/0142688 A1
(43) Pub. Date: Jun. 4, 2009

(54) COMPOSITION FOR COATING CARRIER PARTICLES

(75) Inventors: Brian S. Giannetto, Livonia, NY (US); Christopher M. Pattison, Rochester, NY (US); Thomas C. Dombroski, Rochester, NY (US); Brian E. Moore, Ontario, NY (US); Thomas J. Budny, Nokomis, FL (US); Padam K. Angra, Penfield, NY (US); Zhaoyi M. Masucci, Penfield, NY (US); Bernard A. Kelly, Ontario, NY (US)

Correspondence Address: PILLSBURY WINTHROP SHAW PITTMAN, LLP;XEROX CORPORATION, P.O. BOX 10500, MCLEAN, VA, 22102, US

(73) Assignee: XEROX CORPORATION, Norwalk, CT (US)

(21) Appl. No.: 12/026,392

(22) Filed: Feb. 5, 2008

Related U.S. Application Data
(60) Provisional application No. 61/005,081, filed on Nov. 30, 2007.

(51) Int. Cl. G03G 9/00

(52) U.S. Cl. 430/111.1

(57) ABSTRACT

A dry powder carrier coating composition that may be used to coat carrier particles that imparts desired triboelectric charging characteristics and conductivity values to make the carrier particles more insulative. In embodiments, the coating composition includes a styrene acrylate copolymer.

### CROSS REFERENCE TO RELATED APPLICATIONS

This application is a non-provisional application claiming priority from U.S. Provisional Application No. 61/005,081, filed on Nov. 30, 2007, the contents of which are herein incorporated by reference in their entirety.

### BACKGROUND

Herein disclosed are embodiments that relate generally to carrier particles that may be used in a xerographic system. The embodiments relate to an semi-conductive coating material for xerographic carriers which imparts the desired triboelectric charging characteristics and conductivity values. For example, the present embodiments provide a styrene acrylate copolymer for use in coating carrier particles to impart the carrier with the desired properties. Also, the embodiments are useful in powder coated carriers.

The electrostatographic process, and particularly the xerographic process, involves the formation of an electrostatic latent image on a photoreceptor, followed by development of the image with a developer, and subsequent transfer of the image to a suitable substrate. Numerous different types of xerographic imaging processes are known wherein, for example, insulative developer particles, semi conductive developer particles, or conductive developer particles are selected depending on the development systems used. It is of great importance that such developer compositions are associated with the appropriate triboelectric charging values as it is these values that enable continued formation of developed images of high quality and excellent resolution. In two component developer compositions, carrier particles are used in charging the toner particles.

The resulting toners can be selected for known electrophotographic imaging and printing processes, including digital color processes. The toners are especially useful for imaging processes, specifically xerographic processes, which usually require high toner transfer efficiency such as those having a compact machine design without a cleaner or those that are designed to provide high quality colored images with excellent image resolution, signal-to-noise ratio and image uniformity, and for imaging systems wherein excellent glossy images are generated.

Carrier particles in part consist of a roughly spherical core, often referred to as the “carrier core,” which may be made from a variety of materials. The core is typically coated with a resin. This resin may be made from a polymer or copolymer. The resin may have conductive material or charge enhancing additives incorporated into it to provide the carrier particles with more desirable and consistent triboelectric properties. The resin may be in the form of a powder, which may be used to coat the carrier particle. Often the powder or resin is referred to as the “carrier coating” or “coating.”

One common way of obtaining carrier coating is in the form of powder via emulsion polymerization. This particular method of polymerization has been described in patents, for example, U.S. Pat. No. 6,042,981, incorporated herein by reference. Emulsion polymerization, yielding excellent control over particle size and size distribution, is most typically accomplished by the continuous addition of monomer to a suitable reaction vessel containing water.

There is illustrated in U.S. Pat. No. 4,233,387, the disclosure of which is totally incorporated herein by reference, coated carrier components comprised of finely divided toner particles clinging to the surface of the carrier particles. Specifically, there is disclosed in this patent coated carrier particles obtained by mixing carrier core particles of an average diameter of from between about 30 microns to about 1,000 microns with from about 0.05 percent to about 3 percent by weight, based on the weight of the coated carrier particles, of thermoplastic or thermosetting resin particles. The resulting mixture is then dry blended until the resin particles adhere to the carrier core by mechanical impaction, and/or electrostatic attraction. Thereafter, the mixture is heated to a temperature of from about 320° F. to about 650° F. for a period of 20 minutes to about 120 minutes, enabling the resin particles to melt and fuse on the carrier core.

There is illustrated in U.S. Pat. Nos. 4,937,166 and 4,935,326, the disclosures of which are totally incorporated herein by reference, carrier containing a mixture of polymers, such as two polymers, not in close proximity in the triboelectric series. Moreover, in U.S. Pat. No. 4,810,611, the disclosure of which is totally incorporated herein by reference, there is disclosed the addition to carrier coatings of colorless conductive metal halides in an amount of from about 25 to about 75 weight percent, such halides including copper iodide, copper fluoride, and mixtures thereof. The appropriate components and processes of the U.S. Pat. Nos. 4,937,166 and 4,935,326 patents may be selected for the present disclosure in embodiments thereof. The present disclosure has the advantage over this prior art of achieving high positive triboelectric charge on the carrier particles, that is high, up to about 150 negative triboelectric charge, is imparted to the toner particles developed onto a photoreceptor in, for example, a xerographic development environment. Further, the full range of electrical properties of the carrier particles can be achieved at high triboelectric charging values, from carrier conductivities of 10⁻¹⁷ mho/cm to 10⁻⁶ mho/cm, that is, from the insulative to the conductive regime, and the carrier triboelectric charge and carrier conductivity can be varied and preselected.

Also of interest is U.S. Pat. No. 5,656,408, the disclosure of which is totally incorporated herein by reference, which discloses a carrier composition comprised of a core with a coating thereover comprised of a polyester, and which polyester comprises linear portions and crosslinked portions, and wherein said crosslinked portions are comprised of high density crosslinked microgel particles.

When resin coated carrier particles are prepared by powder coating process the majority of the coating materials are fused to the carrier surface thereby reducing the number of toner impaction sites on the carrier. Additionally, there can be achieved with the process of the present disclosure and the carriers thereof, independent of one another, desirable triboelectric charging characteristics and conductivity values; that is, for example, the triboelectric charging parameter is not necessarily dependent on the carrier coating weight as is believed to be the situation with the process of U.S. Pat. No. 4,233,387, the disclosure of which is totally incorporated herein by reference, wherein an increase in coating weight on the carrier particles may function to also permit an increase in the triboelectric charging characteristics. Specifically, therefore, with the carrier compositions and process of the present disclosure there can be formulated developers with selected triboelectric charging characteristics and/or conductivity values in a number of different combinations. Thus, for example, there can be formulated in accordance with the invention of the present application developers with conductivities as determined in a magnetic brush conducting cell of from about 10-17 (ohm-cm)−1 to about 10-6 (ohm-cm)−1, more specifically from about 10-14 (ohm-cm)−1 to about 10-7 (ohm-cm)−1, and yet more specifically from about 10-12 (ohm-cm)−1 to about 10-8 (ohm-cm)−1, and carrier triboelectric charging values as illustrated herein as determined by the known Faraday Cage technique. Thus, the developers of the present disclosure can be formulated with conductivity values in a certain range with different triboelectric charging characteristics by, for example, maintaining the same total coating weight on the carrier particles.

Disclosed in U.S. Pat. No. 5,847,038, the disclosure of which is totally incorporated herein by reference, is a process which comprises subjecting a mixture of a polymer, a conductive component and an additive to mechanical energy of from about 1 to about 20 kilowatt hours per kilogram and an intensity of from about 20 to about 90 kilowatts per kilogram, and wherein said subjecting is accomplished until said additive is substantially permanently embedded in said polymer.

Various coated carrier particles for use in electrostatographic developers for the development of electrostatic latent images are also described in patents. For example, U.S. Pat. No. 3,590,000, discloses carrier particles that may consist of various cores, including steel, with a polymer coating thereover. The polymer coating may also be in admixture with other suitable polymers, and more specifically, with a second polymer, such as a fluoropolymer. A fluoropolymer commonly used for carrier coatings is polyvinylidene fluoride (also known under the tradename KYNAR 301F).

However, polyvinylidene fluoride cannot be used with all xerographic systems due to an adverse interaction that occurs between fluorinated polymers and specific xerographic subsystems which causes print quality defects such as toner hot off-set temperature (HOT) degradation.

Thus, there is a need for a carrier coating that uses a polymer having similar charging characteristics as fluorinated polymers but without the adverse reactions described above. Further, it is desirable that such a carrier coating maintains the desirable qualities imparted by the fluorinated polymers such as good triboelectric charging characteristics and conductivity values.

### BRIEF SUMMARY

The present embodiments include a carrier coating composition comprising polymethyl methacrylate, melamine, a conductive filler, and a charge controlling agent, wherein the carrier coating composition is used for dry powder coating carrier particles.

Another embodiment provides a carrier comprising a core particle and a dry powder coating composition, the composition comprising a styrene acrylate copolymer, polymethyl methacrylate, melamine, a conductive filler, and a charge controlling agent, wherein the core particle has wrinkled surface morphology and the dry powder coating composition is disposed on the surface of the core particle.

Yet another embodiment provides a developer comprising toner and a carrier, wherein the carrier further comprises a core having a wrinkled surface morphology and a dry powder coating composition disposed on the surface of the core, the composition comprising a styrene acrylate copolymer, polymethyl methacrylate, melamine, a conductive filler, and a charge controlling agent.

### BRIEF DESCRIPTION OF THE DRAWINGS

For a better understanding, reference may be had to the accompanying figures.

FIG. 1 is a photograph of surface morphology of a core having a measurement of G2 (mid- to high-end) as assessed qualitatively by scanning electron microscope (SEM) in accordance with the present embodiments;

FIG. 2 is a photograph of surface morphology of a core having a measurement of G3 as assessed qualitatively by SEM in accordance with the present embodiments; and

FIG. 3 is a photograph of surface morphology of a core having a measurement of G4 as assessed qualitatively by SEM in accordance with the present embodiments.

### DETAILED DESCRIPTION

In the following description, it is understood that other embodiments may be used and structural and operational changes may be made without departing from the scope of the present embodiments.

The present embodiments relate to dry powder coating composition for carrier particles that exhibit triboelectric charging characteristics and conductivity values similar to that of polyvinylidene fluoride but does not comprise any fluorinated polymers. In embodiments, the coating comprises a styrene acrylate copolymer, for example, MP5000 (available commercially from Soken Chemical & Engineering Co. Ltd., Tokyo, Japan) in place of polyvinylidene fluoride in the carrier coating. Use of such a styrene acrylate copolymer provides similar triboelectric charging characteristics and conductivity that is achieved from polyvinylidene fluoride, but without any adverse interactions with the xerographic system that would otherwise be suffered with a fluorinated polymer.

MP5000 is a negative charging styrene acrylate copolymer (Tg=105° C., 221° F.). A carrier coating employing MP5000 as a replacement material for polyvinylidene fluoride exhibits the same triboelectric characteristics and conductivity as a carrier coating using polyvinylidene fluoride (e.g., KYNAR 301F). Namely, as MP5000 is increased, the triboelectric charging decreases, and as MP5000 is increased, the conductivity value increases (as measured in LogCond). Thus, increasing the amount of the styrene acrylate copolymer in the coating makes the carrier more insulative.

A carrier in accordance with the present disclosure comprises a core (core particle) dry powder coated with a coating composition that comprises a mixture of MP5000, polymethyl methacrylate (PMMA) and melamine. In specific embodiments, the styrene acrylate copolymer is present in an amount of from about 0.5 percent to about 60 percent by weight of the total weight of the carrier coating composition. The styrene acrylate copolymer may be present in an amount of from about 0.005 percent to about 1.2 percent by weight of the carrier. In embodiments, the PMMA may be present in an amount of from about 40 percent to about 100 percent by weight of the carrier coating composition. The PMMA may be present in an amount of about 0.4 percent to about 2 percent by weight of the carrier. In other embodiments, the melamine may be present in an amount of from about 0.5 percent to about 60 percent by weight of the total weight of the carrier coating composition. The melamine may be present in an amount of from about 0.005 percent to about 1.2 percent by weight of the carrier.

In further embodiments, a conductive filler and a charge controlling agent (CCA) may also be included in the mixture. In such embodiments, the conductive filler may be present in an amount of from about 0.5 percent to about 50 percent by weight of the total weight of the carrier coating composition. The conductive filler may be present in an amount of from about 0.005 percent to about 0.5 percent by weight of the carrier. The charge controlling agent may be present in an amount of from about 0.5 percent to about 25 percent by weight of the total weight of the carrier coating composition. The charge controlling agent may be present in an amount of from about 0.005 percent to about 0.5 percent by weight of the carrier. The charge controlling agents, generally dispersed as an additive to the carrier coating are used to stabilize electric characteristics. In specific embodiments, the charge controlling agent is a quaternary ammonium salt compound. For example, the charge controlling agent may be BONTRON P51 (available from Orient Corporation of America, Kenilworth, N.J.), having the chemical name benzyl-tributyl-ammonium-4-hydroxy-naphthalene-1-sulfonate.

Various types of conductive filler may be incorporated into the present embodiments. The conductive material described may be any suitable material exhibiting conductivity, e.g., carbon fillers, metal oxides like tin oxide, metals, carbon black, and the like, whose size and surface area provide the proper conductivity range. In embodiments, eeonomer can be used as the conductive material. Eeonomer is a carbon black that has been coated with an intrinsically conductive polymer such as polyanaline. This material can be used as a conductive filler particle that goes in the binder resin. An exemplary carbon black is VULCAN XC72 (available from Cabot Corporation; Boston, Mass.), which has a particle size of about 0.03 micrometers, and a surface area of about 250 m²/g. The coating composition described herein enables carriers to achieve a wide range of conductivity. Carriers using the composition may exhibit conductivity of from about 10⁻⁵ to about 10⁻¹⁷ ∩cm⁻¹ as measured, for example, across a 0.05 inch magnetic brush at an applied potential of 600 volts, and wherein the coating coverage encompasses from about 10 percent to about 100 percent of the carrier core. The conductive filler is incorporated into the polymer particles using techniques well known in the art including the use of various types of mixing and/or electrostatic attraction, mechanical impaction, dry-blending, thermal fusion and others.

In accordance with the above, a specific carrier of the present disclosure comprises a core coated with a dry powder coating composition that comprises a mixture of MP5000, PMMA, melamine, carbon black and BONTRON P51.

The core particle may be selected from any suitable solid carrier core materials. The core preferably should possess properties that will enable the toner particles to acquire a positive charge or a negative charge, and that will permit desirable flow properties in the developer reservoir present in the xerographic imaging apparatus. Other carrier core properties that may be considered in selecting the core material include, for example, suitable magnetic characteristics that will permit magnetic brush formation in magnetic brush development processes. The core should also preferably possess desirable mechanical aging characteristics. Carrier cores having a diameter in a range of, for example, about 10 micrometers to about 400 micrometers may be used. In further embodiments, the carriers are, for example, about 20 micrometers to about 100 micrometers.

Examples of carrier cores that may be selected include, but are not limited to, iron, steel, ferrites, magnetites, nickel, and mixtures thereof. In one embodiment, the carrier cores are magnetite. In another embodiment, the carrier cores are steel. In embodiments, the core particles have an average diameter of from about 10 to about 200 microns, as determined by standard laser diffraction techniques. In further embodiments, the core particles have an average diameter of from about 15 to about 80 microns. In a specific embodiment, the carrier core is a spherically shaped ferrite core may have an average diameter of from about 20 micrometers to about 50 micrometers. The resulting carrier particle may have an average diameter of from about 10 to about 200 microns or from about 15 to about 80 microns. In a specific embodiments, the carrier particle may have an average diameter of from about 20 micrometers to about 50 micrometers.

In embodiments, the core particles may individually have a magnetic saturation of about 60-80 emu/g, with a residual magnetization of less than 5 emu/g and coercive force of less than 15 Oe at 3000 Oe. In addition, ferrite core particles may have a powder density as determined by ASTM Test B-212-99 of about 1.95 to about 2.45 g/cm³, a conductivity of about 1.0×10⁻⁷ to about 1.5×10⁻¹¹ (Ωcm)⁻¹, and a breakdown voltage of about 200 to about 1,000 V. The conductivity of the core is measured by applying a 200 V fixed voltage across a 0.05 inch magnetic brush in a static (non-rotating) mode. The resultant current flow through the material is used to calculate the conductivity of the core. The voltage breakdown of the core is measured by applying a fixed rate of increasing voltage across 0.05 inch magnetic brush while under rotation. The applied voltage at which a 10 volt spike across the sample is defined as the breakdown voltage.

In specific embodiments, the core particle is selected from the group consisting of a metal, a metal oxide, a ferrite and mixtures thereof. In such embodiments, the carrier may have a triboelectric charge of from about a positive 20 microcoulombs per gram to about a positive 60 microcoulombs per gram, or from about a positive 20 microcoulombs per gram to about a positive 60 microcoulombs per gram. In embodiments, the carrier may have a conductivity of from about 10⁻¹⁴ (ohm-cm)⁻¹ to about 10⁻⁶ (ohm-cm)⁻¹, or from about 10⁻¹¹ (ohm-cm)⁻¹ to about 10⁻⁶ (ohm-cm)⁻¹.

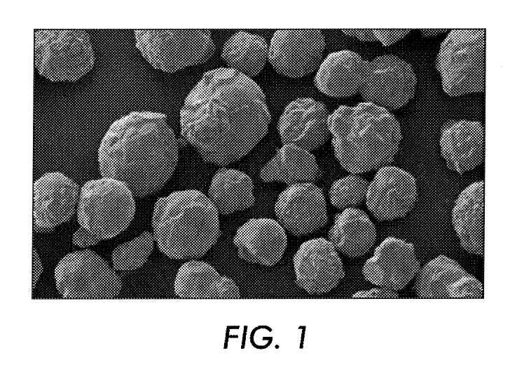

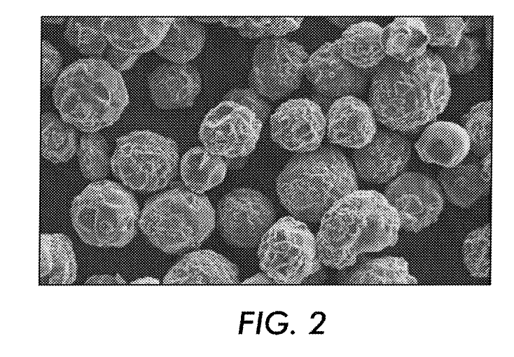

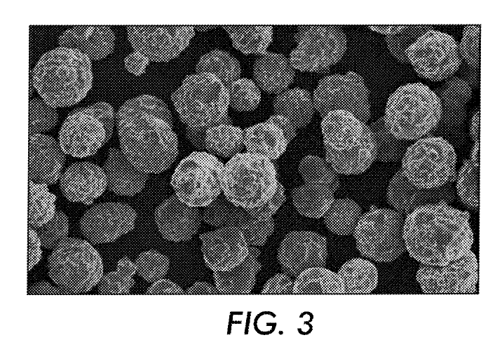

The ferrite core of the present embodiments has a particular wrinkled surface morphology. This morphology enhances the coating process and helps the carrier coating adhere to the carrier core. The particular morphology is used for its balance between degrees of smoothness and roughness. The grading of the surface morphology is designated G2-G4 based on visual inspection. In FIGS. 1-3, the different core surface morphologies representative of each measurement grade are shown as assessed qualitatively by SEM. G2 represents the smoother end of the spectrum, while G4 represents the rougher end of the spectrum. The optimal morphology falls in the mid- to high-end of G2 (slightly wrinkled) to the mid- to high-end of G4 (slightly rough) for the present embodiments.

If the morphology is too rough, then less of the surface of the core is covered by the coating. This is due to the increase in surface area of the core from the increased roughness. The lower surface coverage of the core by the coating can negatively affect triboelectric and conductance properties as well as the aging life of the carrier. With carriers that have low surface coverage of the coating, the edges of the coating surrounding an exposed region of the core can provide a starting point for the coating to be abraded during use as a developer, which in turns shortens the life of the carrier.

If the core surface is too smooth, however, adhesion of the coating to the core can be reduced and the powder coating process becomes more difficult. This is undesirable but may be necessary to achieve the triboelectric or conductive properties desired. The core's wrinkled surface enhances powder coating in two ways. First mechanical adhesion during the mixing step is increased. This allows a more uniform and stable coating of the powders before fusing. When the surface is too smooth, agitation during the fusing step may have to be reduced which may reduce the maximum amount of coating that can applied to the core. Secondly, the wrinkles prevent the coating from shifting on the core surface during fusing when the coating polymer is hot enough to melt flow. This creates a more fully coated carrier with a more uniform thickness. Both of these increase the aging life of the carrier.

Typically, the coating composition covers, for example, about 10 percent to about 100 percent of the surface area of the carrier core using from about 0.18 percent to about 3.0 percent coating weight, or from about 0.4 percent to about 1.5 percent coating weight, or from about 0.6 percent to about 1 percent coating weight. A specific embodiment has a coating composition that covers the surface of the carrier core by using 0.89 percent coating weight.

A non-limiting example of a suitable PMMA material is a polymethyl methacrylate (#MP-116 PMMA) available from Soken Chemical of Japan. Other examples of materials suitable for use as the PMMA component include, but are not limited to, sodium lauryl sulfate PMMA, Soken MP-1451 (small size), different molecular weight PMMAs, and other acrylic polymers and combinations thereof. Suitable comonomers that may be used to form a PMMA copolymer include, for example, monoalkyl or dialkyl amines such as dimethylaminoethyl methacrylate, diethylaminoethyl methacrylate, diisopropylaminoethyl methacrylate, acrylic or methacrylic acids, or fluoroalkyl or perfluorinated acrylic and methacrylic esters, such as, for example fluoro-ethyl methacrylate or fluoro-ethylacrylate.

Examples of materials suitable for use as the melamine component include, but are not limited to melamine formaldehyde resin and any derivatives of such resins. For example, a suitable melamine component is EPOSTAR S melamine formaldehyde, available from Nippon Shokubai Co., LTD, Osaka, Japan.

Various effective suitable means can be used to apply the coating materials to the surface of the carrier core particles. Examples of typical means for this purpose include, but are not limited to, combining the carrier core material and the PMMA/melamine mixture by cascade roll mixing, or tumbling, milling, shaking, electrostatic powder cloud spraying, fluidized bed, electrostatic disc processing, and an electrostatic curtain. Following application of the polymer mixture, heating is initiated to permit flowout of the coating material over the surface of the carrier core. In embodiments, the coating composition is fused to the carrier core in either a rotary kiln or by passing through a heated extruder apparatus.

The concentration of the coating material powder particles, as well as the parameters of the heating step, may be selected to enable the formation of a continuous film of the coating material on the surface of the carrier core, or permit only selected areas of the carrier core to be coated. When selected areas of the carrier core remain uncoated or exposed, the carrier particles will possess electrically conductive properties when the core material comprises a metal. For example, the mixture of carrier core particles and MP5000/PMMA/melamine materials may be heated to a temperature of between from about 200° F. to about 650° F., for a period of time of from, for example, about 10 minutes to about 60 minutes, enabling the MP5000/PMMA/melamine materials to melt and fuse to the carrier core particles. The coated carrier particles are then cooled and thereafter classified to a desired particle size.

The dry powder coating composition of the present embodiments finds particular utility in a variety of xerographic copiers and printers, such as high speed xerographic color copiers, printers, digital copiers and more specifically, wherein color copies with excellent and substantially no background deposits are desirable in copiers, printers, digital copiers, and the combination of xerographic copiers and digital systems.

Developer composition may be prepared by combining a styrene acrylate copolymer/PMMA/melamine coated carrier particle with a toner. The toner is not limited and may be selected as desired for a particular purpose or intended use. Illustrative examples of finely divided toner resins suitable for the developer compositions include, but are not limited to, polyamides, epoxies, polyurethanes, diolefins, vinyl resins, styrene acrylates, styrene methacrylates, styrene butadienes, polyesters such as the polymeric esterification products of a dicarboxylic acid and a diol comprising a diphenol, crosslinked polyesters, and the like. Specific examples of suitable vinyl monomers include styrene, p-chlorostyrene vinyl naphthalene, unsaturated mono-olefins such as ethylene, propylene, butylene and isobutylene; vinyl halides such as vinyl chloride, vinyl bromide, vinyl fluoride, vinyl acetate, vinyl propionate, vinyl benzoate, and vinyl butyrate; vinyl esters like the esters of monocarboxylic acids including methyl acrylate, ethyl acrylate, n-butyl-acrylate, isobutyl acrylate, dodecyl acrylate, n-octyl acrylate, 2-chloroethyl acrylate, phenyl acrylate, methylalphachloracrylate, methyl methacrylate, ethyl methacrylate, and butyl methacrylate; acrylonitrile, methacrylonitrile, acrylamide, vinyl ethers, inclusive of vinyl methyl ether, vinyl isobutyl ether, and vinyl ethyl ether; vinyl ketones inclusive of vinyl methyl ketone, vinyl hexyl ketone and methyl isopropenyl ketone; vinylidene halides such as vinylidene chloride and vinylidene chlorofluoride; N-vinyl indole, N-vinyl pyrrolidone; and the like. Also, there may be selected styrene butadiene copolymers, mixtures thereof, and the like.

One toner resin can be selected from the esterification products of a dicarboxylic acid and a diol comprising a diphenol, as disclosed in U.S. Pat. No. 3,590,000, the disclosure of which is totally incorporated herein by reference. Other suitable toner resins include styrene/methacrylate copolymers; styrene/butadiene copolymers; polyester resins obtained from the reaction of bisphenol A and propylene oxide; and branched polyester resins resulting from the reaction of dimethyl terephthalate, 1,3-butanediol, 1,2-propanediol and pentaerythritol, and reactive extruded polyesters.

Generally, a developer comprises from about 1 part to about 5 parts by weight of toner particles mixed with from about 10 to about 300 parts by weight of carrier particles in accordance with the present disclosure. In further embodiments, developer compositions with mixtures outside these ranges are also possible.

Numerous well known suitable colorants, such as pigments or dyes, can be selected as the colorant for the toner including, for example, cyan, magenta, yellow, red, blue, carbon black, nigrosine dye, lamp black, iron oxides, magnetites, and mixtures thereof. The toner colorant should be present in a sufficient amount to render the toner composition colored. Thus, the colorant particles can be present in amounts of from about 3 percent by weight to about 20 percent by weight, and preferably from about 3 to about 12 weight percent or percent by weight, based on the total weight of the toner composition, although, lesser or greater amounts of colorant particles can be selected. Colorant includes pigment, dye, mixtures thereof, mixtures of pigments, mixtures of dyes, and the like. Specific colorant examples are colored pigments, dyes, and mixtures thereof including, but not limited to, carbon black, such as REGAL 330 carbon black (Cabot Corporation), Acetylene Black, Lamp Black, Aniline Black, Chrome Yellow, Zinc Yellow, Sicofast Yellow, Sunbrite Yellow, Luna Yellow, Novaperm Yellow, Chrome Orange, Bayplast Orange, Cadmium Red, Lithol Scarlet, Hostaperm Red, Fanal Pink, Hostaperm Pink, Lithol Red, Rhodamine Lake B, Brilliant Carmine, Heliogen Blue, Hostaperm Blue, Neopan Blue, PV Fast Blue, Cinquassi Green, Hostaperm Green, titanium dioxide, cobalt, nickel, iron powder, Sicopur 4068 FF, and iron oxides such as MAPICO BLACK (Columbia), NP608 and NP604 (Northern Pigment), Bayferrox 8610 (Bayer), M08699 (Mobay), TMB-100 (Magnox), mixtures thereof and the like.

The colorant, for example, black, cyan, magenta and/or yellow colorant is incorporated in an amount sufficient to impart the desired color to the toner. In general, the pigment or dye is selected in an amount of from about 2 to about 60 percent by weight, and preferably from about 2 to about 9 percent by weight for a color toner and about 3 to about 60 percent by weight for black toner.

For the cyan toner, the toner should contain a suitable cyan pigment and loading so as to enable a broad color gamut similar to that achieved in benchmark lithographic four-color presses. In embodiments, the cyan pigment is comprised of 30 percent PV FAST BLUE (Pigment Blue 15:3) (SUN Chemicals) dispersed in a 70 percent linear propoxylated bisphenol A fumarate and is loaded into the toner in an amount of about 11 percent by weight (corresponding to about 3.3 percent by weight pigment loading). For the yellow toner, the toner should contain a suitable yellow pigment type and loading so as to enable a color gamut as similar to that achieved in benchmark lithographic four-color presses. The pigment can be comprised of 30 percent Sunbrite Yellow (Pigment Yellow 17) obtained from SUN Chemicals dispersed in 70 percent of a linear propoxylated bisphenol A fumarate and is loaded into the toner in an amount of about 27 percent by weight (corresponding to about 8 percent by weight pigment loading).

For the magenta toner, the toner should contain a suitable magenta pigment type and loading to provide a broad color gamut. The magenta pigment can be comprised of 40 percent FANAL PINK (Pigment Red 81:2) (BASF) dispersed in 60 percent of a linear propoxylated bisphenol A fumarate and is loaded into the toner in an amount of about 12 percent by weight (corresponding to about 4.7 percent by weight pigment loading).

When the colorant particles are comprised of magnetites, which are a mixture of iron oxides (FeO, Fe₂O₃) including those commercially available as MAPICO BLACK, they are usually present in the toner composition in an amount of from about 10 percent by weight to about 70 percent by weight, and preferably in an amount of from about 20 percent by weight to about 50 percent by weight.

The resin particles are present in a sufficient, but effective amount, thus when 10 percent by weight of pigment, or colorant, such as carbon black, is contained therein, about 90 percent by weight of resin is selected. Generally, the toner composition is comprised of from about 85 percent to about 97 percent by weight of toner resin particles, and from about 3 percent by weight to about 15 percent by weight of colorant particles.

The developer compositions can be comprised of thermoplastic resin particles, carrier particles and as colorants, magenta, cyan and/or yellow particles, and mixtures thereof. More specifically, illustrative examples of magentas include 1,9-dimethyl-substituted quinacridone and anthraquinone dye identified in the Color Index as CI 60720, CI Dispersed Red 15, a diazo dye identified in the Color Index as CI 26050, CI Solvent Red 19, and the like. Examples of cyans include copper tetra-4(octaecyl sulfonamido) phthalocyanine, X-copper phthalocyanine pigment listed in the Color Index as CI 74160, CI Pigment Blue, and Anthrathrene Blue, identified in the Color Index as CI 69810, Special Blue X-2137, and the like; while illustrative examples of yellows are diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33, 2,5-dimethoxy-4-sulfonanilide phenylazo-4′-chloro-2,5-dimethoxy aceto-acetanilide, permanent Yellow FGL, and the like. The colorants, which include pigments, mixtures of pigments, dyes, mixtures of dyes, mixtures of dyes and pigments, and the like, are generally present in the toner composition in an amount of from about 1 weight percent to about 15 weight percent based on the weight of the toner resin particles.

For further enhancing the positive charging characteristics of the developer compositions illustrated herein, and as optional components there can be incorporated therein known charge enhancing additives inclusive of alkyl pyridinium halides, reference U.S. Pat. No. 4,298,672, the disclosure of which is totally incorporated herein by reference; organic sulfate or sulfonate compositions, reference U.S. Pat. No. 4,338,390, the disclosure of which is totally incorporated herein by reference; distearyl dimethyl ammonium sulfate; metal complexes, E-88, naphthalene sulfonates, quaternary ammonium compounds; and other similar known charge enhancing additives. These additives, which can also include waxes, such as polypropylenes, polyethylenes, and the like, and surface additives of colloidal silicas, are usually incorporated into the toner or carrier coating in an amount of from about 0.1 to about 20 percent by weight, and preferably from about. 1 to about 7 weight percent by weight.

The toner composition can be prepared by a number of known methods including melt blending the toner resin particles, and pigment particles or colorants followed by mechanical attrition. Other methods include emulsion aggregates spray drying, melt dispersion, dispersion polymerization and suspension polymerization. In one dispersion polymerization method, a solvent dispersion of the resin particles and the colorant particles are spray dried under controlled conditions to result in the desired product.

Examples of imaging members selected for the imaging processes illustrated herein are selenium, selenium alloys, and selenium or selenium alloys containing therein additives or dopants such as halogens. Furthermore, there may be selected organic photoreceptors, illustrative examples of which include layered photoresponsive devices comprised of transport layers and photogenerating layers, reference, for example, U.S. Pat. Nos. 4,265,990; 4,585,884; 4,584,253, and 4,563,406, the disclosures of which are totally incorporated herein by reference, and other similar layered photoresponsive devices. Examples of generating layers are trigonal selenium, metal phthalocyanines, perylenes, titanyl phthalocyanines, metal free phthalocyanines and vanadyl phthalocyanines. As charge transport molecules there can be selected, for example, the aryl diamines disclosed in the '990 patent. Also, there can be selected as photogenerating pigments, squaraine compounds, thiapyrillium materials, hydroxy gallium phthalocyanine, and the like. These layered members are conventionally charged negatively thus usually requiring a positively charged toner. Other photoresponsive members may include pigments of polyvinylcarbazole 4-dimethylamino benzylidene, benzhydrazide, 2-benzylidene-aminocarbazole, 4-dimethylamino-benzylidene, (2-nitro-benzylidene)-p-bromoaniline, 2,4-diphenyl-quinazoline, 1,2,4-triazine, 1,5-diphenyl-3-methylpyrazoline 2-(4′-dimethylaminophenyl)-benzoaxzole, 3-aminocarbazole, polyvinyl carbazole-trinitrofluorenone charge transfer complex; and mixtures thereof.

Moreover, the developer compositions are particularly useful in electrostatographic imaging processes and apparatuses wherein there is selected a moving transporting means and a moving charging means; and wherein there is selected a deflected flexible layered imaging member, reference, for example, U.S. Pat. Nos. 4,394,429 and 4,368,970, the disclosures of which are totally incorporated herein by reference. Images obtained with the developer composition of the present disclosure in embodiments possessed acceptable solids, excellent halftones and desirable line resolution with acceptable or substantially no background deposits.

While the description above refers to particular embodiments, it will be understood that many modifications may be made without departing from the spirit thereof. The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

### EXAMPLES

The example set forth herein below and is illustrative of different compositions and conditions that can be used in practicing the present embodiments. All proportions are by weight unless otherwise indicated. It will be apparent, however, that the embodiments can be practiced with many types of compositions and can have many different uses in accordance with the disclosure above and as pointed out hereinafter.

### Example I

Preparation of 0.5 percent by weight of sodium lauryl-sulfate polymethylmethacrylate (SLS PMMA), 0.1 percent by weight of melamine formaldehyde, 0.01 percent by weight of benzyl-tributyl-ammonium-4-hydroxy-naphthalene-1-sulfonate (P51), 0.07 percent by weight of carbon black and 0.07 percent by weight of acrylate-styrene (MP5000) copolymer coated carrier:

A carrier coating composition was made in which MP5000 was employed in place of KYNAR 301F. The composition comprised MP5000, PMMA, melamine, carbon black, and P-51 CCA.

Various effective suitable means can be used to apply the coating materials to the surface of the carrier core particles. Examples of typical means for this purpose include, but are not limited to, combining the carrier core material and the PMMA/melamine/P51/MP5000/Carbon Black mixture by cascade roll mixing, or tumbling, milling, shaking, electrostatic powder cloud spraying, fluidized bed, electrostatic disc processing, and an electrostatic curtain. Following application of the polymer mixture, heating is initiated to permit flowout of the coating material over the surface of the carrier core. In embodiments, the coating composition is fused to the carrier core in either a rotary kiln or by passing through a heated extruder apparatus. There resulted a continuous uniform polymer coating on the core. The carrier powder coating process is generally known and is described, for example, in U.S. Pat. Nos. 4,935,326; 5,015,550; 4,937,166; 5,002,846 and 5,213,936, the disclosures of which are totally incorporated herein by reference.

The final product was comprised of a carrier core with a total of 0.73% coating weight of 0.5 percent by weight of SLS PMMA, 0.1 percent by weight of melamine, 0.01 percent by weight of P51, 0.07 percent by weight of carbon black and 0.07 percent by weight of MP5000 coated carrier. The weight percent of this carrier was determined in this and all following carrier examples by dividing the difference between the weights of the fused carrier and the carrier core by the weight of the fused carrier.

A developer composition was then prepared in this and all following Examples by mixing 30 grams of the above prepared coated carrier with 2.4 grams of an 8.45 micron volume median diameter (volume average diameter) black toner. This developer was conditioned for, for example, 1 hour at 50 percent RH and 70° F. The resulting developer was shaken on a paint shaker at 715 rpm in a 4 ounce jar and a 0.30 gram coated carrier sample was removed after 10 minutes. Thereafter, the triboelectric charge on the carrier particles was determined by the known Faraday Cage process, and there was measured on the carrier a negative charge of 46.7 microcoulombs per gram. Further, set voltages were imposed to a 0.1 inch magnetic brush of carrier particles and the resulting current was measured to determine conductive properties. The measured current by imposing a voltage potential at 225, 400 and 625 volts across the brush was 2.17×10⁻¹⁰, 2.69×10⁻⁸, 6.34×10⁻⁷ (ohm-cm)⁻¹ respectively.

As shown in Table 1, the formulation of subsequent carrier examples was varied to determine the effects of MP5000 on triboelectric charge and conductivity. Test results demonstrate that as MP5000 increased, the triboelectric charge decreased while LogCond increased, and the carrier became more insulative. A carrier coating using KYNAR 301F exhibits the same results. Table 1 shows a complete overview of the conductive properties of carriers made with MP5000.

TABLE 1

| | example | | | | | | |
|---|---|---|---|---|---|---|---|
| | 1 | 2 | 3 | 4 | 5 | 6 | 8 |
| SLS-PMMA (%) | 0.5% | 0.5% | 0.5% | 0.5% | 0.5% | 0.5% | 0.7% |
| Melamine (%) | 0.1% | 0.1% | 0.1% | 0.1% | 0.1% | 0.1% | 0.1% |
| P51 (%) | 0.01% | 0.01% | 0.01% | 0.01% | 0.01% | 0.01% | 0.01% |
| Carbon Black (%) | 0.07% | 0.07% | 0.14% | 0.14% | 0.13% | 0.13% | 0.11% |
| MP5000 (%) | 0.07% | 0.27% | 0.07% | 0.27% | 0.06% | 0.25% | 0.00% |
| voltage | current | current | current | current | current | current | current |
| 225 | 2.17E−10 | 6.05E−11 | 5.35E−08 | 1.42E−08 | 3.27E−08 | 3.54E−09 | 2.59E−09 |
| 400 | 2.69E−08 | 4.03E−09 | 4.31E−07 | 1.41E−07 | 3.97E−07 | 1.01E−07 | 1.01E−07 |
| 625 | 6.34E−07 | 1.02E−07 | 2.14E−06 | 1.01E−06 | 1.78E−06 | 9.56E−07 | 1.02E−06 |
| triboelectric charge | 46.7 | 41.7 | 38.3 | 34.8 | 39.4 | 36.3 | 50.3 |

All the patents and applications referred to herein are hereby specifically, and totally incorporated herein by reference in their entirety in the instant specification.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. A carrier coating composition comprising:
a polymethyl methacrylate;
melamine;
a conductive filler; and
a charge controlling agent, wherein the carrier coating composition is used for dry powder coating carrier particles.

2. The carrier coating composition of claim 1, wherein the conductive filler is a metal oxide.

3. The carrier coating composition of claim 1, wherein the conductive filler is carbon black.

4. The carrier coating composition of claim 1, wherein the charge controlling agent is a quaternary ammonium salt compound.

5. The carrier coating composition of claim 4, wherein the charge controlling agent is benzyl-tributyl-ammonium-4-hydroxy-naphthalene-1-sulfonate.

6. The carrier coating composition of claim 1 further including a styrene acrylate copolymer.

7. The carrier coating composition of claim 6, wherein the styrene acrylate copolymer is present in an amount of from about 0.5 percent to about 60 percent by weight of the total weight of the carrier coating composition.

8. The carrier coating composition of claim 1, wherein the polymethyl methacrylate is present in an amount of from about 40 percent to about 100 percent by weight of the total weight of the carrier coating composition.

9. The carrier coating composition of claim 1, wherein the melamine is present in an amount of from about 0.5 percent to about 60 percent by weight of the total weight of the carrier coating composition.

10. The carrier coating composition of claim 1, wherein the conductive filler is present in an amount of from about 0.5 percent to about 50 percent by weight of the total weight of the carrier coating composition.

11. The carrier coating composition of claim 1, wherein the charge controlling agent is present in an amount of from about 0.5 percent to about 25 percent by weight of the total weight of the carrier coating composition.

12. A carrier comprising a core particle and a dry powder coating composition, the composition comprising:
a styrene acrylate copolymer;
polymethyl methacrylate;
melamine;
a conductive filler; and
a charge controlling agent, wherein the core particle has a wrinkled surface morphology and the dry powder coating composition is disposed on the surface of the core particle.

13. The carrier of claim 12, wherein the styrene acrylate copolymer is present in an amount of from about 0.005 percent to about 1.2 percent by weight of the carrier, the polymethyl methacrylate is present in an amount of from about 0.4 percent to about 2 percent by weight of the carrier, the melamine is present in an amount of from about 0.005 percent to about 1.2 percent by weight of the carrier, the conductive filler is present in an amount of from about 0.005 percent to about 0.5 percent by weight of the carrier, and the charge controlling agent is present in an amount of from about 0.005 percent to about 0.5 percent by weight of the carrier.

14. The carrier of claim 12, wherein the coating is present in an amount of from about 0.18 percent to about 3 percent by weight of the carrier.

15. The carrier of claim 12, wherein the coating covers from about 10 percent to about 100 percent of the carrier core.

16. The carrier of claim 12 having an average diameter of from about 20 micrometers to about 50 micrometers.

17. The carrier of claim 12, wherein the carrier core particles have an average particle diameter of from about 15 micrometers to about 80 micrometers.

18. The carrier of claim 12, wherein the core particle is selected from the group consisting of a metal, a metal oxide, a ferrite and mixtures thereof.

19. The carrier of claim 12 having a triboelectric charge of from about 20 microcoulombs per gram to about 60 microcoulombs per gram.

20. The carrier of claim 12 having a conductivity of from about 10⁻¹⁴ (ohm-cm)⁻¹ to about 10⁻⁶ (ohm-cm)⁻¹.

21. A developer comprising toner and a carrier, wherein the carrier further comprises a core having a wrinkled surface morphology and a dry powder coating composition disposed on the surface of the core, the composition comprising:
a styrene acrylate copolymer;
polymethyl methacrylate;
melamine;
a conductive filler; and
a charge controlling agent.
